(19) United States
(12) Patent Application Publication
(10) Pub. No.: US 2006/0117725 A1
(43) Pub. Date: Jun. 8, 2006

(54) Dust-separating apparatus for a vacuum cleaner and dust-separating method for the same

(76) Inventors: Jang-keun Oh, Gwangju-city (KR); Sung-wook Kang, Seoul (KR); Jung-gyun Han, Busan (KR); Georgiy Severinets, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 11/103,178

(22) Filed: Apr. 11, 2005

(30) Foreign Application Priority Data
Dec. 2, 2004 (KR) 2004-100258

(51) Int. Cl. B01D 45/08

(52) U.S. Cl. 55/462

(57) ABSTRACT

A dust-separating apparatus for a vacuum cleaner separates dust from air without a filer and without a cyclone by repeatedly colliding air and air-borne dust particles against surfaces as the air passes through the dust-separating apparatus. The dust-separating apparatus includes: an air inlet formed in an upper surface of the dust-separating apparatus; an inlet pipe coupled to the air inlet that guides dust-laden air downwardly into the dust-separating apparatus, the end of which opens just above the bottom surface of the dust-separating apparatus where dust particles collide with the bottom surface. An air outlet is formed in a sidewall of the dust-separating apparatus. One or more guide members formed inside the dust-separating apparatus prevent dust from flowing upwardly and provide surfaces against which air-borne particles can collide. A removable dust collection bin stores collected dust.

### CROSS-REFERENCE TO RELATED APPLICATIONS

This application claims the benefit of Korean Patent Application No. 2004-100258, filed Dec. 2, 2004 in the Korean Intellectual Property Office, the disclosure of which is incorporated herein by reference.

### FIELD OF THE INVENTION

The present invention relates to a vacuum cleaner, and more particularly, to a dust-separating apparatus for a vacuum cleaner, which separates dust from air by repeatedly colliding dust-laden air against surfaces, thereby causing suspended dust particles to separate out.

### BACKGROUND OF THE INVENTION

At least one prior art dust-separating apparatus of a vacuum cleaner uses a dust bag to collect dust, however, such dust bags, must be frequently replaced. Because of this, many vacuum cleaners now use centrifugal dust filters to separate dust from drawn-in air. An example of such a dust-separating apparatus is a cyclone dust-separating apparatus, one such structure being disclosed in Korean Patent Publication No. 2001-0104810. Such a cyclone dust-separating apparatus includes an air inlet formed at the edge of a sidewall thereof to generate a circular airflow and an air outlet formed on an upper wall thereof. Air flowing into the air inlet circulates inside the cyclone dust-separating apparatus so that dust or dirt heavier than the collected air is separated from the collected air by centrifugal force and collected by gravity in a dust bin located at the bottom or lower portion of the cyclone dust-separating apparatus.

As is known, centrifugal force increases with an increase of a rotation radius of a cyclone dust-separating apparatus. Thus, in order to improve dust separation, the radius of curvature of a cyclonic dust separator should be as large as practical. Also, as disclosed in Korean Patent Publication No. 2002-0073464, an additional grill or filter is provided at an air outlet to improve dust collection.

Centrifugal or cyclonic dust separators are recognized as being effective separating dust without having to replace a dust bag. However, the air inlet of a cyclonic dust separator is preferably formed at the edge of a sidewall of the dust-separating apparatus in a location and with a geometry that will either generate or assist in the generation of a rotary air flow. As stated above, the radius of the dust-separating apparatus must be relatively large to increase centrifugal force on air-borne dust. Therefore, an inflow path inside a cleaner is complicated, and the dust-separating apparatus cannot be made compact. As a result, a dust or particle separator that does not rely on cyclonic air flow would be an improvement over the prior art cyclonic dust separators.

### SUMMARY OF THE INVENTION

In consideration of the foregoing, an object of the present invention is to provide a dust-separating apparatus including an improved air inflow and outflow path.

Another object of the preferred invention is to provide a dust-separating apparatus having a simple structure and an improved internal inflow path.

Another object of the preferred invention is to provide a dust-separating having a relatively simple structure and a freely variable inside diameter.

In light of the foregoing objects, there is provided a dust-separating apparatus for a vacuum cleaner that does not rely on cyclonic air currents. The preferred embodiment of the dust separating apparatus includes a cylindrically-shaped dust separating apparatus having an air inlet in a top cover and an orthogonal air outlet in a side wall, however, alternate embodiments include air inlet paths and air outlet paths that could also be parallel to each other as well as any angle there between. An inlet pipe coupled to the air inlet guides air into the dust-separating apparatus, toward the bottom of the dust-separating apparatus. Inertia of dust particles suspended in the air causes most of the suspended dust particles to strike or collide with the bottom surface of the dust-collecting apparatus where they are held in place by gravity and separated from the in-flowing air.

Air that strikes the bottom surface of the dust separating apparatus curls upwardly or “upstream” of the in-flowing air, toward an air outlet formed in a sidewall of the dust-separating apparatus. Dust particles that do not collide with the bottom surface of the dust-collecting apparatus, and which continue to be carried by air, upwardly toward the air outlet, collide with one or more guide members formed inside the dust-separating apparatus to extend away from the inside wall of the dust-separating apparatus and which slant downwardly to prevent air-borne dust from flowing upstream and out of the dust-separating apparatus. A dust collection bin installed under the guide member, stores the collected dust.

The guide members extend away from the inside surface of the cylindrically shaped dust-separating apparatus toward the inlet pipe but do not contact the inlet pipe. Instead, the inlet pipe and the guide members form an annular-shaped opening through which outbound air flows.

The guide member may include a first guide member and a second guide member installed above the first guide member, and a second air passage hole may be formed between the second guide member and the inlet pipe so as to pass the air. An end of the first guide member may be positioned under an end of the inlet pipe, and a first air passage hole may be formed between the end of the first guide member and an end of the inlet pipe so as to pass the air.

The inlet pipe may penetrate through an opening of the first guide member so as to position the end of the first guide member above the end of the inlet pipe.

The guide member may slantingly protrude from the sidewall of the dust-separating apparatus, and the inlet pipe may penetrate through the upper wall of the dust-separating apparatus to protrude.

The dust-separating apparatus may further include a filter installed at an air path formed between at least one of the first and second guide members and the inlet pipe so as to pass the air.

The dust collection bin is in the shape of a frustum of a right circular cone.

According to another aspect of the preferred invention, there is provided a dust-separating apparatus for a vacuum cleaner, separating dust from air including the dust flowing thereinto by an indraft force, the dust-separating apparatus including: an air inlet formed in the center of an upper wall of the dust-separating apparatus; and an air outlet formed at a sidewall of the dust-separating apparatus. Here, the dust is separated from the air flowing into through the air inlet, and then the air is discharged through the air outlet.

### BRIEF DESCRIPTION OF THE DRAWINGS

The above aspects and features of the preferred invention will be more apparent by describing certain embodiments of the preferred invention with reference to the accompanying drawings, in which:

FIG. 1 is a side view of a dust-separating apparatus according to the preferred embodiment;

FIG. 2 is a plan view of the dust-separating apparatus shown in FIG. 1;

FIG. 3 is a cross-sectional view of the dust-separating apparatus, taken along line 3-3 shown in FIG. 2;

FIG. 4A is a plan view of a first guide member shown in FIG. 3;

FIG. 4B is a plan view of a second guide member shown in FIG. 3;

FIG. 5 is a cross-sectional view of the dust-separating apparatus, taken along line 5-5 shown in FIG. 1;

FIG. 6 is a cross-sectional view illustrating a second air passage hole shown in FIG. 3 at which a filter is mounted;

FIG. 7 is a cross-sectional view of a dust-separating apparatus according to another embodiment of the preferred invention;

FIG. 8 is a cross-sectional view illustrating a second air passage hole of FIG. 7 at which a filter is mounted; and

FIG. 9 is a flowchart of a dust-separating method according to an embodiment of the preferred invention.

### DETAILED DESCRIPTION OF THE PREFERRED EMBODIMENT

Certain embodiments of the preferred invention will be described in greater detail with reference to the accompanying drawings.

In the following description, same drawing reference numerals are used for the same elements even in different drawings. Also, well-known functions or constructions are not described in detail since they would tend to obscure the invention in unnecessary detail.

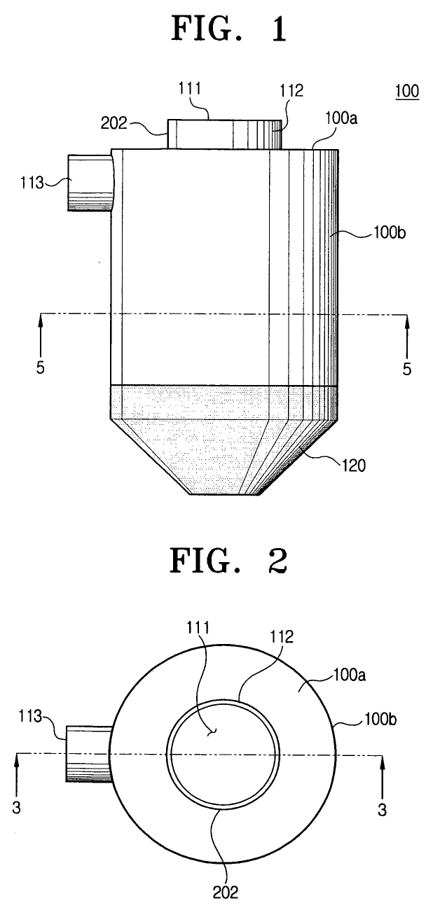

Referring to FIGS. 1 through 3, a preferred embodiment of a dust-separating apparatus 100 includes a substantially planar upper cover 100a, a cylindrical dust separating apparatus sidewall 100b, a circular air inlet 111, a cylindrical air inlet pipe 112 that extends towards the bottom surface 120a, a circular air outlet 113, a cylindrical air outlet pipe 114, a dust collection bin 120, in the shape of the frustum of a right circular cone, which has bottom surface 120a, and a guide member 130 comprised of one or more inverted-funnel shaped panels or surfaces 131 and 132 that slantingly extend downwardly away from the inside wall of the sidewall 100b. In the preferred embodiment, the dust-separating apparatus 100 is made to have an inside diameter D2 of 154 mm and a height H1 of 250 mm so as to be suitable for a household cleaner.

The upper cover 100a and the sidewall 100b form a cylindrical vessel that separates dust from collected air by using both inertia and centrifugal force as described below.

The circular air inlet 111 is located in the center of the upper cover 100a and allows dust-laden collected air to flow into the dust-separating apparatus 100 vertically. In the preferred embodiment, the circular air inlet 111 is formed as the interior of the inlet pipe 112.

The inlet pipe 112 penetrates through the upper cover 100a so that a portion of it extends above the upper cover 100a and the other portion thereof is inserted into the dust-separating apparatus 100 and extends downwardly, into the dust-separating apparatus 100 where it terminates just above the bottom surface 120a. Accordingly, air flowing through the the inlet pipe 112 is guided or directed downwardly, into the dust-separating apparatus 100 and toward the bottom surface.

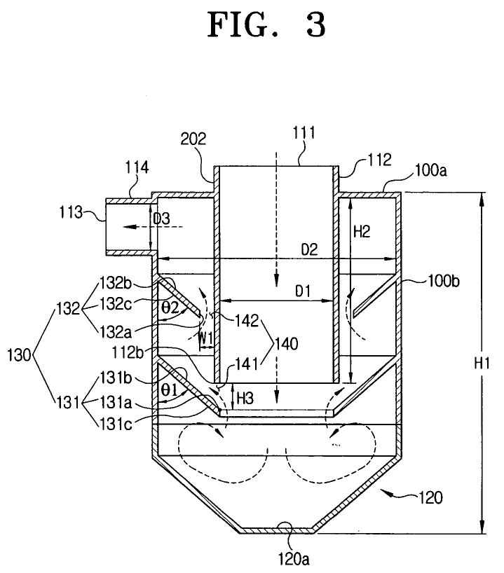

As best seen in FIG. 3, dust suspended in the air that descends through the inlet pipe 112 continues descending by inertia, after the air and dust leaves the bottom end of the air inlet pipe 112. Inertia causes such dust particles to collide against the bottom 120a of the dust collection bin 120 so as to separate from the collected air. The separated dust is collected on the bottom 120a of the dust collection bin 120 under the force of gravity, from which it can be disposed of by detaching the dust collection bin 120 from the dust separating apparatus 100. The air traveling downwardly through the air inlet pipe 112 also collides against the bottom 120a of the dust collection bin 120 but after the air collides with the bottom surface 120a, it readily curls upward along and against the inclined surfaces of the cone-shaped bin 120 and ascends upwardly toward the outlet 113.

Since dust is separated from air using an inertial force, the air inlet 111 does not need to be sized, shaped or arranged in the cover 100a to generate a rotating or cyclonic air flow, which separates dirt using centrifugal force. As a result, the inside diameter D2 of the dust-separating apparatus 100 does not need to be large to form a circular airflow. Thus, the dust-separating apparatus 100 can be made relatively compact so as to have a simple structure and an inside diameter D2 that is freely variable.

In order to effectively guide the collected air into the dust-separating apparatus 100, an internal portion of the inlet pipe 112 should have a height H2, 0.6 to 0.8 times the overall height H1 of the dust-separating apparatus 100. The inside diameter D1 of the inlet pipe 112 should be 0.5 to 0.6 times the overall inside diameter D2 of the dust-separating apparatus 100.

An air outlet 113 is formed in the sidewall 100b to discharge the air separated from the dust. The air outlet 113 is preferably formed as part of the sidewall 100b, however, in the preferred embodiment, the air outlet 113 is embodied as a cylindrical outlet pipe 114, installed into the sidewall 100b. In the preferred embodiment, the outlet pipe 114 has an inside diameter D3 of 36 mm.

The air separated from the dust ascends inside the dust-separating apparatus 100 and discharges through the air outlet 113. The air outlet 113 is preferably located at the top of the dust-separating apparatus 100 so that fine dust that does not collide with the bottom surface 120a and which remains suspended in the ascending air can be subsequently intercepted by the elements 131 and 132 of a guide member 130 inside the dust-separating apparatus 100, which operated to separate fine dust particles from the air. As a result, the air can be further purified and then discharged through the air outlet 113.

The air outlet 113 is not sized, shaped or positioned to impart or aid in the creation of a rotating or cyclonic air flow, and thus not need to be installed at a particular location in the sidewall 100b. Therefore, the air outlet 113 can be sized, shaped and installed to reduce the size of the dust-separating apparatus 100.

The dust collection bin 120 is preferably in the shape of an inverted frustum of a right-circular cone. The bottom surface 120a is formed by one surface of the frustum. The dust collection bin 120 is attachable to and detachable from the sidewall 100b under a first guide member 131 so as to easily dump collected dust.

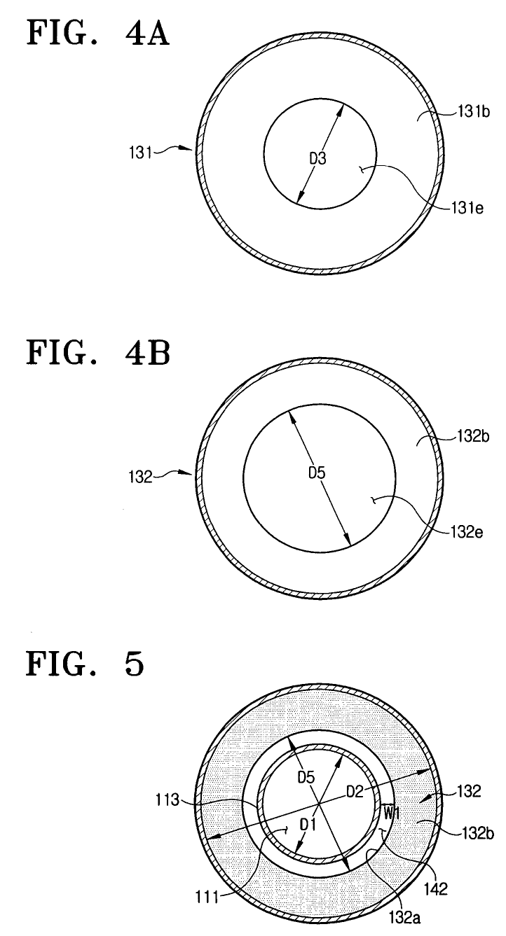

Referring to FIGS. 3 through 5, the guide member 130 includes a plurality of guide member sections identified by reference numerals 131 and 132. They prevent dust collected in the dust collection bin 120 and fine dust that does not strike the bottom surface 120a, from flowing upstream and out of the air outlet 113. The guide member sections 131 and 132 slantingly protrude from the sidewall 100b of the dust-separating apparatus 100, inwardly toward the dust collection bin 120.

Due to the guide member 130, an additional grill member does not need to be installed at the air outlet 113 as in prior art cyclone dust separators. Thus, the structure of the dust-separating apparatus 100 can be simplified and an air filter eliminated.

The guide member 130 preferably includes a plurality of guide members, however, in a case where the guide member 130 includes an excessively large number of guide members, an inflow path inside the dust-separating apparatus 100 becomes complicated and airflow through the apparatus 100 impeded. As a result, in the preferred embodiment, the guide member 130 preferably includes first and second guide members 131 and 132.

Referring to FIGS. 3 and 4A, the first guide member 131 is bonded, welded, screwed or otherwise attached to the sidewall 100b to forms a single body together with the sidewall 100b located above the dust collection bin 120. The first guide member 131 is a section or portion of an inverted funnel having an inclination angle of θ1 with respect to the sidewall 100b. It extends inwardly from the sidewall 100b and downwardly toward the dust collection bin 120. It forms an opening 131e with a diameter D3 in the center thereof.

Dust that collects on the upper surface 131b of the first guide member 131 can fall into the dust collection bin 120 due to the inclination angle θ1. Dust contained in the air that ascends from the bottom surface 120a passes through the first air passage hole 141. Some of the dust collected in the dust collection bin 120 is carried by the air but collides against a lower surface 131c of the first guide member 131 to fall back into the dirt collection bin 120. The opening 131e may form the first air passage hole 141 along with the inlet pipe 112 and is described in detail later.

The second guide member 132 is also bonded, welded, screwed or otherwise attached to the sidewall 100b to form a single body together with the sidewall 100b and is positioned between the first guide member 131 and the air outlet 113. The second guide member 132 is also a funnel-shaped rib having an inclination angle of θ2. It extends downwardly toward the dust collection bin 120 and including an opening 132e with a diameter of D5 in the center thereof.

Dust piled on an upper surface 132b of the second guide member 132 may slide on the upper surface 132b and then fall on the upper surface 131b of the first guide member 131 due to the inclination angle θ2. Dust contained in air ascending to pass through the second air passage hole 142 collides against a lower surface 132c of the second guide member 132 and then falls on the upper surface 131b of the first guide member 131. The dust piled on the upper surface 131b of the first guide member 131 slides on the upper surface 131b to fall into the dust collection bin 120. The opening 132e forms the second air passage hole 142 along with the inlet pipe 112. This will be described in detail later.

Referring to FIG. 3, the air passage hole 140 includes a plurality of air passage holes inside the dust-separating apparatus 100 due to the guide member 130 and the inlet pipe 112. In the preferred embodiment, the air passage hole 140 includes the first and second air passage holes 141 and 142.

The first air passage hole 141 is an air inflow path formed by positioning an end of the first guide member 131 under an end of the inlet pipe 112. In more detail, the first air passage hole 141 is a belt-shaped hole, which has a height H3 and is formed by an upper surface corner 131a of the first guide member 131 and an end 112b of the inlet pipe 112.

The height H3 of the first air passage hole 141 may vary depending on the inclination angle θ1 of the first guide member 131 and the internal height H2 of the inlet pipe 112. For example, as the inclination angle θ1 of the first guide member 131 is small and the internal height H2 of the inlet pipe 112 is low, the height H3 of the first air passage hole 141 is high. For reference, in the preferred embodiment, the height H3 of the second air passage hole 142 is 15 mm.

The second air passage hole 142 is an air inflow path formed around the inlet pipe 112 so as to pass air between the second guide member 132 and the inlet pipe 112. For this purpose, the inlet pipe 112 penetrates through the opening 132e of the second guide member 132. In more detail, the second air passage hole 142 is a belt-shaped hole formed between a right side 132a of the second guide member 132 and the inlet pipe 112 so as to have a width W1 (see FIG. 4).

The width W1 of the second air passage hole 142 may vary depending on the inclination angle θ2 of the second guide member 132 and the inside diameter D1 of the inlet pipe 112. For example, as the inclination angle θ2 of the second guide member 132 is small and the inside diameter D1 of the inlet pipe 112 is small, the width W1 of the second air passage hole 142 increases. For reference, in the preferred embodiment, the width W1 of the second air passage hole 142 is 8.5 mm.

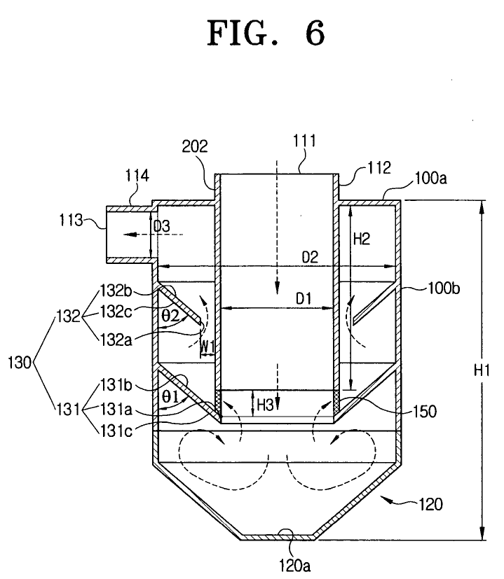

As shown in FIG. 6, a filter 150 may be bonded to or inserted into the first air passage hole 141 shown in FIG. 3 to improve dust collection efficiency. Air filters may be installed at either one or both of the first and second air passage holes 141 and 142 as shown in FIG. 3.

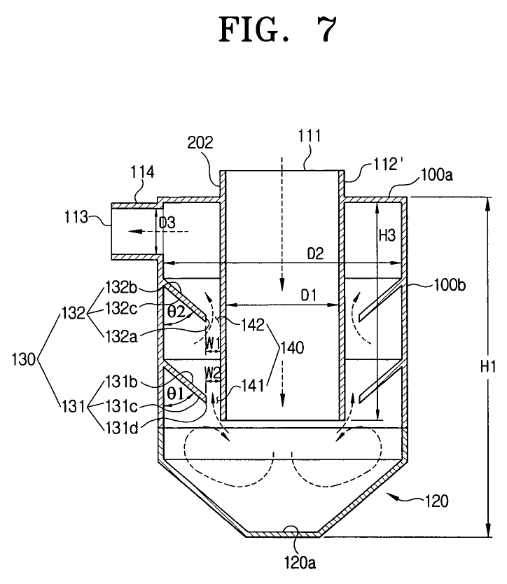

FIG. 7 is a cross-sectional view of a dust-separating apparatus according to another embodiment of the preferred invention. The first air passage hole 141 is formed by positioning an end of the first guide member 131 above the bottom 200 end of an inlet pipe 112′. In other words, the inlet pipe 112′ has a height H3 to extend through the opening 131e of the first guide member 131 shown in FIG. 4A so as to form the annulus-shaped first air passage hole 141 as an air inflow path passing air between the first guide member 131 and the outer surface 202 of the inlet pipe 112′.

In more detail, the first air passage hole 141 is an annular-shaped opening or hole formed between the end 131d of the first guide member 131 and the outside wall 202 of the inlet pipe 112′. As can be seen in the figure, the first air passage hole has a width W2.

The width W2 of the first air passage hole 141 can be varied by the inclination angle θ1 of the first guide member 131, the length of the guide member 131 and the outside diameter of the inlet pipe 112′. For example, as the inclination angle θ1 of the first guide member 131 is small and the outside diameter of the inlet pipe 112′ is small, the width W2 of the first air passage hole 141 increases. The other elements of the preferred embodiment are the same as those of the previous embodiment, denoted by like reference numerals, and will not be described herein.

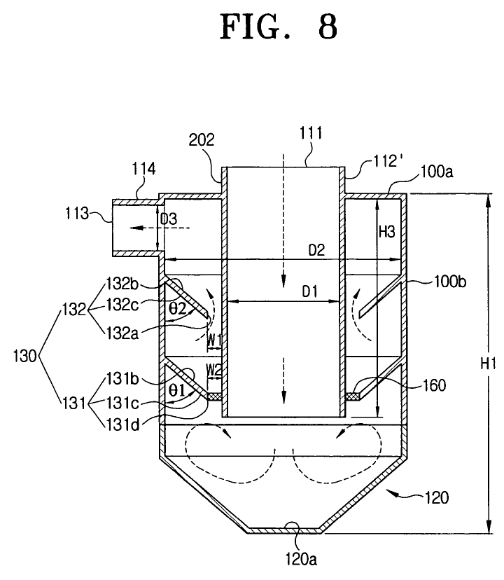

As shown in FIG. 8, a filter 160 may also be installed at the first air passage hole 141 to improve dust collection efficiency. If desired or necessary, filters 160 may be installed at either or both of the first and second air passage holes 141 and 142 shown in FIG. 7.

The operation of the dust-separating apparatus 100 shown in FIG. 1 will now be described with reference to FIGS. 1 through 5 and 9.

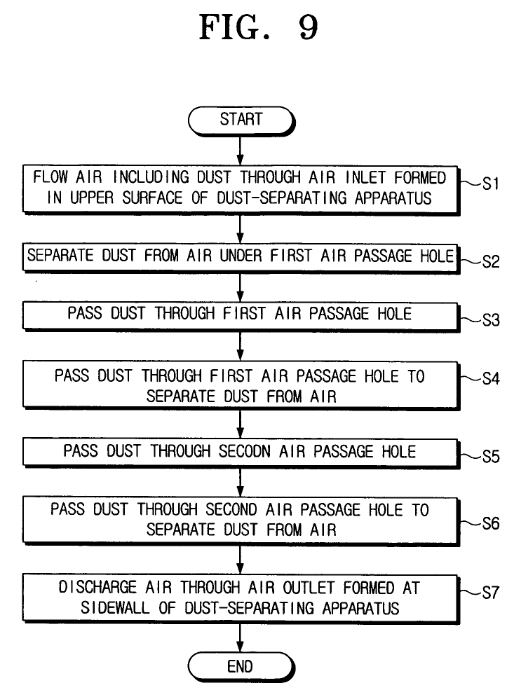

Referring to FIGS. 3 and 9, when a vacuum cleaner (not shown) operates, an indraft force is generated such that air is drawn from the separating apparatus through the circular air outlet 113. As a result of the evacuation of air through the air outlet 113, air containing dust flows into the air inlet 111 formed in the upper cover 100a of the dust-separating apparatus 100. The air passes through an end of the inlet pipe 112 and then descends through the pipe 112 to the bottom 120a of the dust collection bin 120.

Relatively heavy dust particles contained in the collected air continues to descend past the end 200 of the pipe 112 by inertia. These particles collide against the bottom 120a of the dust collection bin 120 and are usually thereafter separated from the collected air. Such dirt particles pile up on the bottom 120a of the dust collection bin 120.

The air separated from the dust changes its direction as it collides against the bottom surface 120a and ascends where it collides with the lower surface 131c of the first guide member 131. Thereafter, the air passes through the first air passage hole 141 to continue its travel upward toward the air outlet pipe 113.

In a case where fine dust does not separate from the air after passing through the first air passage hole 141, fine dust carried in the upwardly flowing air collides against the lower surface 132c of the second guide member 132, and separates from the air under the second guide member 132, while the air changes direction and passes through the second air passage hole 142.

Any dust still remaining after collision with the second guide member separates as the air re-passes through the second air passage hole 142, and falls on the upper surface 131b of the first guide member 131. The fallen dust slides on the upper surface 131b of the first guide member 131, passes through the first air passage hole 141, and falls into the dust collection bin 120.

The air from which the dust is removed through the second air passage hole 142 is discharged outside the dust-separating apparatus 100 through the air outlet 113 formed in the sidewall 100b of the dust-separating apparatus 100.

As described above, in a dust-separating apparatus for a vacuum cleaner and a dust-separating method for the same according to the preferred invention, an air inlet can be installed in an upper cover of the dust-separating apparatus, and an air outlet can be formed in a sidewall of the dust-separating apparatus. Thus, the inflow and outflow paths and the separation structure for air can vary to provide inflow and outflow paths that can range from being parallel to being orthogonal flows as shown in the figures. As a result, the air inlet does not need to be installed at the edge of the sidewall of the dust-separating apparatus to generate a circular airflow. In particular, an inside diameter of the dust-separating apparatus can be made compact.

Also, an additional grill member does not need to be installed at the air outlet, and the dust-separating apparatus includes an inlet pipe and a guide member so as to have simple structure. Thus, manufacturing cost for the dust-separating apparatus can be reduced.

Moreover, an inflow path of the dust-separating apparatus can be simplified. Thus, pressure loss of air passing through the inflow path can be reduced and loss of an in draft force can be reduced.

The foregoing embodiment and advantages are merely exemplary and are not to be construed as limiting the preferred invention. The preferred teaching can be readily applied to other types of apparatuses. Also, the description of the embodiments of the preferred invention is intended to be illustrative, and not to limit the scope of the claims, and many alternatives, modifications, and variations will be apparent to those skilled in the art.

What is claimed is:

1. A cylindrically shaped dust-separating apparatus for a vacuum cleaner, separating dust from a dust-laden air which flows in by an in draft force, the dust-separating apparatus comprising:
an air inlet formed in an upper surface of the dust-separating apparatus;
an inlet pipe coupled to the air inlet to guide the air into and toward the bottom of the dust-separating apparatus;
an air outlet formed in a sidewall of the dust-separating apparatus;
at least one or more air guide members extending from the sidewall toward the inside of the dust-separating apparatus to prevent air borne dust from flowing upward toward the air outlet; and
a dust collection bin installed under the guide member to store collected dust.

2. The dust-separating apparatus of claim 1, wherein the at least one or more guide member comprises an annular opening through which the inlet pipe extends.

3. The dust-separating apparatus of claim 2, wherein:
the guide member comprises a first guide member and a second guide member installed above the first guide member, and
a second annular-shaped air passage hole is formed between the second guide member and the inlet pipe so as to pass the air.

4. The dust-separating apparatus of claim 3, wherein:
an end of the first guide member is positioned under a bottom end of the inlet pipe, and
a first air passage hole is formed between the end of the first guide member and the bottom end of the inlet pipe so as to pass the air.

5. The dust-separating apparatus of claim 3, wherein the inlet pipe extends through an opening of the first guide member so as to position the end of the first guide member above the bottom end of the inlet pipe.

6. The dust-separating apparatus of claim 3, wherein:
the guide member protrudes slantingly from the sidewall of the dust-separating apparatus, and
the inlet pipe penetrates through an upper section of the sidewall of the dust-separating apparatus to protrude.

7. The dust-separating apparatus of claim 2, further comprising:
a filter installed at an air path formed between at least one of the first and second guide members and the inlet pipe so as to pass the air.

8. The dust-separating apparatus of claim 2, wherein the dust collection bin is in the shape of the frustum of a right circular cone.

9. A dust-separating apparatus for a vacuum cleaner, comprising an air inlet and an air outlet, and separating dust from air comprising the dust flowing thereinto by an indraft force, the dust-separating apparatus comprising:
the air inlet formed in the center of an upper cover of the dust-separating apparatus; and
the air outlet formed in a sidewall of the dust-separating apparatus,
wherein the dust is separated from the air flowing into through the air inlet, and then the air is discharged through the air outlet.

10. The dust-separating apparatus of claim 9, further comprising:
at least one or more guide member slantingly protruding from the sidewall of the dust-separating apparatus downward.

11. The dust-separating apparatus of claim 10, further comprising:
a dust collection bin detachable from the sidewall of the dust-separating apparatus under the at least one or more guide member to store collected dust.

12. A dust-separating method comprising:
flowing dust laden air through an air inlet formed in an upper cover of a dust-separating apparatus toward a bottom surface of the dust-separating apparatus;
directing the air through an air passage hole formed between a guide member and an inlet pipe installed inside the dust-separating apparatus;
separating the dust from the air and collect the separated dust in a dust collection bin; and
discharging the air through an air outlet formed at a sidewall of the dust-separating apparatus.

13. The dust-separating method of claim 12, wherein passing the air through the air passage hole comprises:
passing the air through a first air passage hole; and
passing the air through a second air passage hole.

14. The dust-separating method of claim 13, wherein separating the dust from the air comprises:
separating the dust from the air under the first air passage hole;
passing the air through the first air passage hole and separating the dust form the air; and
passing the air through the second air passage hole and separating the dust from the air.
